(19) United States
(12) Patent Application Publication
(10) Pub. No.: US 2023/0325519 A1
(43) Pub. Date: Oct. 12, 2023

(54) SECURING COMPUTER SOURCE CODE

(71) Applicant: BLACKSWAN TECHNOLOGIES INC., LEWES, DE (US)

(72) Inventors: Asher STERKIN, Tel Aviv (IL); Etzik BEGA, Modiin (IL)

(73) Assignee: BLACKSWAN TECHNOLOGIES INC., LEWES, DE (US)

(21) Appl. No.: 18/024,845

(22) PCT Filed: Sep. 5, 2021
(86) PCT No.: PCT/US2021/049179

§ 371 Date: Mar. 6, 2023

(51) Int. Cl. G06F 21/62; G06F 21/60

(52) U.S. Cl. CPC G06F 21/6218; G06F 21/602

(57) ABSTRACT

A system comprising at least one hardware processor; and a non-transitory computer-readable storage medium having stored thereon program instructions, the program instructions executable by the at least one hardware processor to: receive computer source code for deploying in a cloud environment associated with a cloud computing platform, configure a first cloud environment on the cloud computing platform, wherein the configuring comprises implementing an initial access permissions scheme with respect to resources in the first cloud environment, configure a second cloud environment on the cloud computing platform, wherein the cloud-based environment comprises a cloud storage instance, store the received computer source code in the cloud storage instance, and implement an import infrastructure extension in the second cloud environment, to perform imports from the cloud storage instance directly into the first cloud computation environment.

### CROSS-REFERENCE TO RELATED APPLICATIONS

This application is a PCT International Application claiming the benefit of U.S. Patent Application No. 63/075,164, filed Sep. 6, 2020, entitled: “SECURING COMPUTER SOURCE CODE”, which is hereby incorporated by reference in its entirety.

### FIELD OF THE INVENTION

The present invention is in the field of methods for computer program security.

### BACKGROUND

On-premises computing solutions can be defined as an in-house hosted software solution (e.g., on local servers, a private cloud, or a private account in a public cloud) that may be supported by a third party vendor or provider. This is in contrast to software-as-service (SaaS) solutions, where the software is hosted and maintained by the same vendor and allows users to access information remotely.

There are certain benefits to on-premises hosting, especially in terms of customization, and security and regulatory compliance (e.g., privacy regulation), where internal IT staff has complete control over the environment, making enforcement of regulatory requirements comparatively easier.

However, from the product or service provider's point of view, permitting local hosting of a software product makes it more difficult to protect the intellectual property off the provide form loss or compromise.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive computer source code for deploying in a cloud environment associated with a cloud computing platform, configure a first cloud environment on the cloud computing platform, wherein the configuring comprises implementing an initial access permissions scheme with respect to resources in the first cloud environment, configure a second cloud environment on the cloud computing platform, wherein the cloud-based environment comprises a cloud storage instance, store the received computer source code in the cloud storage instance, and implement an import infrastructure extension in the second cloud environment, to perform imports from the cloud storage instance directly into the first cloud computation environment.

There is also provided, in an embodiment, a method comprising: receiving computer source code for deploying in a cloud environment associated with a cloud computing platform; configuring a first cloud environment on the cloud computing platform, wherein the configuring comprises implementing an initial access permissions scheme with respect to resources in the first cloud environment; configuring a second cloud environment on the cloud computing platform, wherein the cloud-based environment comprises a cloud storage instance; storing the received computer source code in the cloud storage instance; and implementing an import infrastructure extension in the second cloud environment, to perform imports from the cloud storage instance directly into the first cloud computation environment.

There is further provided, in an embodiment, a computer program product comprising a non-transitory computer-readable storage medium having program code embodied therewith, the program code executable by at least one hardware processor to: receive computer source code for deploying in a cloud environment associated with a cloud computing platform; configure a first cloud environment on the cloud computing platform, wherein the configuring comprises implementing an initial access permissions scheme with respect to resources in the first cloud environment; configure a second cloud environment on the cloud computing platform, wherein the cloud-based environment comprises a cloud storage instance; store the received computer source code in the cloud storage instance; and implement an import infrastructure extension in the second cloud environment, to perform imports from the cloud storage instance directly into the first cloud computation environment.

In some embodiments, the cloud computing platform is Amazon Web Services (AWS) and the cloud storage is AWS Simple Storage Service (S3).

In some embodiments, the cloud resource allocation and access permissions scheme is implemented using the AWS CloudFormation Stack.

In some embodiments, the program instructions are further executable to lock down, and the method further comprises locking down, the permission scheme, such that no modifications to the Cloud Formation Stack and its template are permitted.

In some embodiments, access permission to the source code is granted to any Lambda Function ARN upon initial validation of the Cloud Formation Stack instance integrity.

In some embodiments, the program instructions are further executable to, and the method further comprises the steps of: (i) generate periodic snapshots of a current access permissions scheme in the first cloud environment; and (ii) compare each of the periodic snapshots to the initial access permissions scheme, to identify any drift from the initial access permissions scheme.

In some embodiments, the import infrastructure extension is configured for a dynamic runtime environment, and wherein the importing is performed directly into a cloud computation unit associated with the first cloud environment.

In some embodiments, the cloud computation unit is AWS Lambda.

In some embodiments the dynamic runtime environment is one of: Python, JavaScript family, JVM family, Julia, .NET family, Linux Shared Objects, and Microsoft DLLs.

In some embodiments, the initial permissions scheme is configured for providing alerts to the second cloud environment with respect to any attempted violations of the initial permissions scheme.

In some embodiments, the program instructions are further executable to modify, and the method further comprises modifying, the source code by at least one of: code obfuscation, code compilation, and code encryption.

In addition to the exemplary aspects and embodiments described above, further aspects and embodiments will become apparent by reference to the figures and by study of the following detailed description.

Embodiments of the invention may include a method of securing computer source code on a cloud computing platform by at least one processor of the cloud computing platform. Embodiments of the method may include storing one or more compiled modules of computer source code on a cloud storage of a first cloud environment, associated with the cloud computing platform; associating the one or more compiled modules with an access permission scheme, representing access permissions of one or more computation units of a second cloud environment to the compiled modules; receiving, from the one or more computing units of the second cloud environment, a cryptographically verified, run-time request to access the one or more modules of compiled computer source code; and allowing the cloud computing unit to import the one or more compiled modules to local, transient memory on the second cloud environment, based on the cryptographic verification of the run-time request, and on the access permission scheme.

According to some embodiments, the cloud computing unit may be configured, or defined to execute the imported one or more compiled modules of computer source code from the local, transient memory, and delete the compiled modules of computer source code therefrom upon termination of execution.

According to some embodiments, the access permission scheme may include: (a) an access control policy; and (b) an authorization data structure, representing authorization of one or more computing units to import one or more compiled modules of computer source from the first cloud environment.

Embodiments of the invention may include associating the access control policy to the cloud computing unit, where said access control policy (a) determines read-only access permission of the cloud computing unit to the modules of computer source code, and (b) disallows the cloud computing unit storage of the imported modules of computer source code to local cloud storage.

According to some embodiments, the cloud computing platform may be an Amazon Web Services (AWS) platform, the cloud computing unit may be an AWS Lambda service, the local memory may be a random access memory (RAM) of the AWS Lambda service, and the access control policy may be an AWS Identity and Access Management (IAM) policy. In such embodiments, the access permission scheme may be implemented using an AWS CloudFormation Stack.

Embodiments of the invention may include encrypting the one or more compiled modules of computer source code on the cloud storage of a first cloud environment. Embodiments of the invention may allow the cloud computing unit to import the one or more modules of source code by providing, to the cloud computing unit, a just in time (JIT) decryption key, to allow the cloud computing unit to execute said the one or more compiled modules of source code.

Embodiments of the invention may include repeatedly querying a resource manager of the second cloud environment regarding configuration of the computing unit; producing one or more snapshots of the computing unit configuration, based on said queries; identifying a drift in the configuration of the computing unit, based on said snapshots; and applying at least one security measure against the computing unit, based on said identified drift.

Additionally, or alternatively, embodiments of the invention may include associating a resource manager of the second cloud environment with a third-party ledger account, on a third cloud environment; providing the access permission scheme to the third-party ledger account; repeatedly querying a resource manager of the second cloud environment regarding configuration of the computing unit; producing snapshots of the computing unit configuration, based on said queries; identifying a suspected drift in the configuration of the computing unit, based on said snapshots; sending a request message to the third-party ledger, said message may include a request to confirm occurrence of drift in the configuration of the computing unit, based on at least one snapshot and the access permission scheme; and applying at least one security measure against the computing unit, based on a response from the third-party ledger.

According to some embodiments, the authorization data structure may include an association between: (a) at least one module of computer source code, (b) an authorization level for importing the at least one module of computer source code, and (c) identification of one or more entities upon which the authorization level may be applied. The identification of one or more entities may be selected from a list consisting of: an identification of a cloud platform, an identification of a cloud account, an identification of a cloud region, and an identification of one of more computing unit instances.

Embodiments of the invention may include a system for securing computer source code on a cloud computing platform. Embodiments of the system may include: a non-transitory memory device, wherein modules of instruction code may be stored, and at least one processor associated with the memory device, and configured to execute the modules of instruction code on the cloud platform.

Upon execution of said modules of instruction code, the at least one processor may be configured to store one or more compiled modules of computer source code on a cloud storage of a first cloud environment, associated with the cloud computing platform; associate the one or more compiled modules with an access permission scheme, representing access permissions of one or more computation units of a second cloud environment to the compiled modules; receive, from the one or more computing units of the second cloud environment, a cryptographically verified, run-time request to access the one or more modules of compiled computer source code; and allow the cloud computing unit to import the one or more compiled modules to local, transient memory on the second cloud environment, based on the cryptographic verification of the run-time request, and on the access permission scheme.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 schematically illustrates a serverless cloud computing environment, according to some embodiments of the present disclosure;

FIGS. 2A and 2B are screenshots depicting examples of account dashboards of a cloud computing platform (e.g., AWS);

FIGS. 2C-2H are schematic block diagrams, depicting examples of deployment of components of a system for securing computer source code on a cloud computing platform, according to some embodiments;

FIG. 3 schematically illustrates a domain-specific virtual machine architecture, according to some embodiments of the present disclosure;

FIG. 4 schematically illustrates concurrency structure optimization, according to some embodiments of the present disclosure;

FIG. 5 schematically illustrates computation unit structure optimization, according to some embodiments of the present disclosure;

FIG. 6 is a flowchart of the functional steps in a process for utilizing a constructed functional computing environment using available cloud services, according to some embodiments of the present disclosure;

FIG. 7 schematically illustrates an integration of the present protection scheme with a shared file system;

FIG. 8 is a block diagram depicting a computing device, which may be included within an embodiment of a system for securing computer source code on a cloud computing platform, according to some embodiments;

FIG. 9 is a flow diagram depicting a method of securing computer source code on a cloud computing platform, according to some embodiments; and

FIG. 10 is a flow diagram depicting another method of securing computer source code on a cloud computing platform, according to some embodiments.

### DETAILED DESCRIPTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

Disclosed herein are a system, method, and computer program product which provide for a protection scheme for securing of computer source code hosted on customer's cloud account against potential loss and compromise. In some embodiments, the source code may be hosted in a private cloud environment of an enterprise, and/or using a cloud private account of an enterprise on a public cloud platform.

The term “cloud platform” may be used herein to refer to a configuration of distributed storage and/or computing services that may be publicly offered by providers over the Internet. Examples for such cloud platforms may include Amazon Web Services (AWS), Microsoft Azure, and Google Cloud Platform (GCP).

The term “cloud environment” may be used herein to refer to a configuration of distributed storage and/or computing infrastructure that may pertain to a specific user or organization. For example, a cloud environment may include a private account on a cloud platform (e.g., the Amazon AWS cloud platform) that may facilitate distributed storage, computing and security services, as defined by the cloud platform (e.g., AWS).

The terms vendor, provider and ISV may be used herein interchangeably to indicate a person or organization who may provide a cloud-based computer source code, that may represent a computer function or process. Such vendor, provider or ISV may facilitate run-time access to the provided source code via a cloud-based computing environment, as elaborated herein.

The terms enterprise, client, and customer may be used interchangeably to indicate a person or organization who may consume a source code of a provider or ISV via a client cloud-based computing account, as elaborated herein.

By way of background, in many cases, highly-regulated and similar organizations are prohibited from and/or avoid using the SaaS model, and require a vendor to deploy the provided service on-premises, e.g., on their private cloud environment and/or using their private accounts, where they are the root administrators and have full control over the accounts.

This presents vendors and service providers with a potential risk of exposing their intellectual property to potential loss or compromise on hosting premises out of their immediate control.

Deploying a software service locally or on-premises, in an enterprise private cloud or even private account in a public third-party cloud platform, means that the source code is fully exposed and at the reach of the hosting enterprise. This means, e.g., the enterprise developers have the ability to access, read, download, study, and even modify the hosted source code.

Conversely, the vendor does not have root admin privileges at the enterprise accounts, and thus has no ongoing access (for security or due regulatory reasons), and remains unaware of any illicit activities in connection with its deployed product.

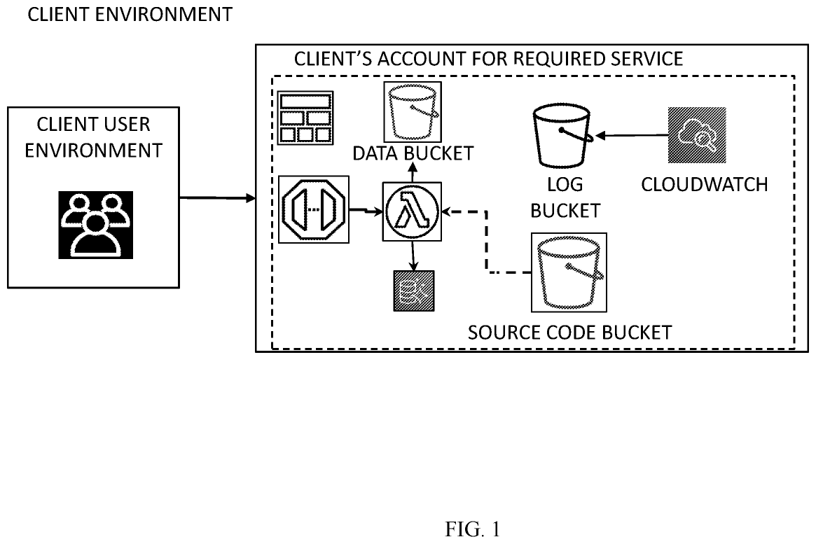

FIG. 1 is a schematic illustration of a non-limiting example of local deployment of computer source code at private cloud account of an enterprise client. It may be appreciated by a person skilled in the art that examples brought herein relate to Amazon Web Services (AWS) accounts, but embodiments of the invention may also be applied to computing platforms of other vendors, including for example Microsoft's Azure, and Google's GCP, with the required adaptations.

For example, a service implemented over a cloud computing account such as an AWS cloud computing account, in a serverless architecture, may use an Application Programming Interface (API) gateway 170, such as the Amazon AWS API Gateway. API gateway 170 may be a service that permits developers to create APIs used by applications to access data or functionality from backend services. For example, API Gateway 170 may allow creating RESTful APIs and Web Socket APIs that enable real-time two-way communication applications.

In another example, a cloud computing environment such as AWS may include one or more computing units or containers 120 such as the “AWS Lambda Functions”. Computing unit (e.g., Lambda function) 120 may be, or may include a virtual container, which may execute and manage application functionalities, as known in the art.

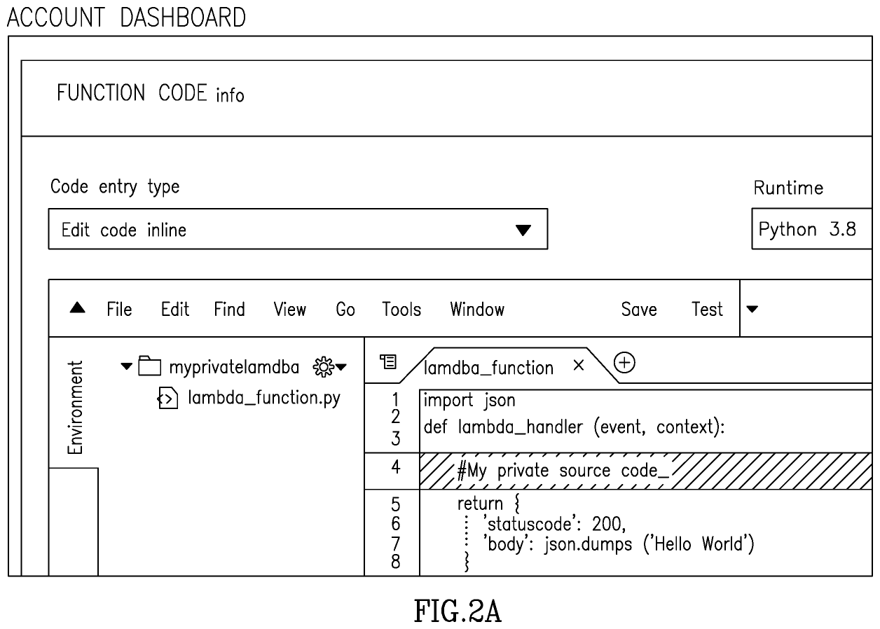

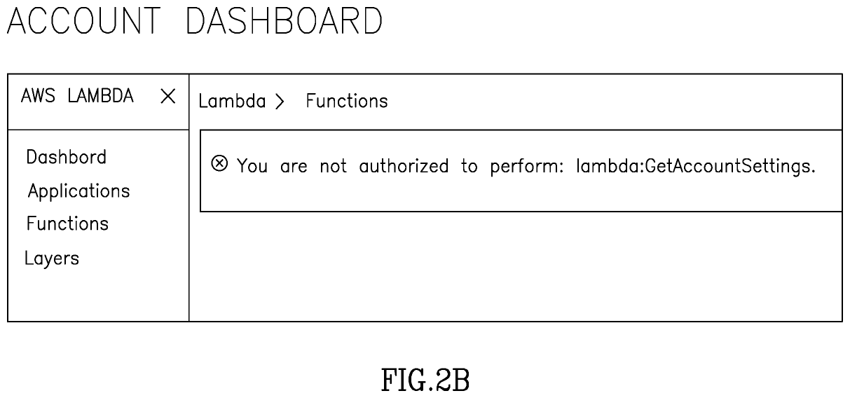

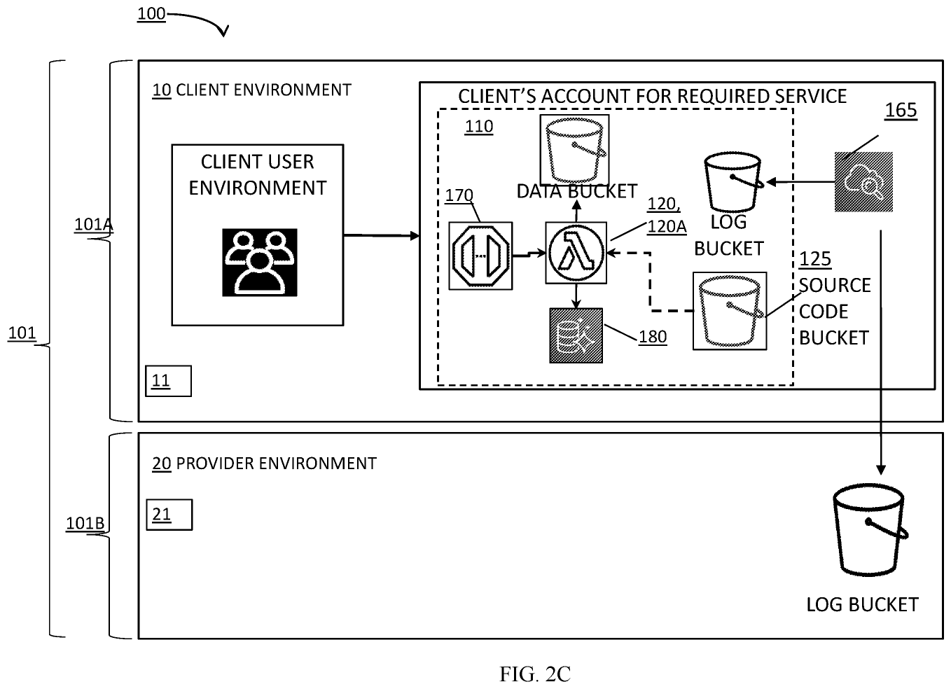

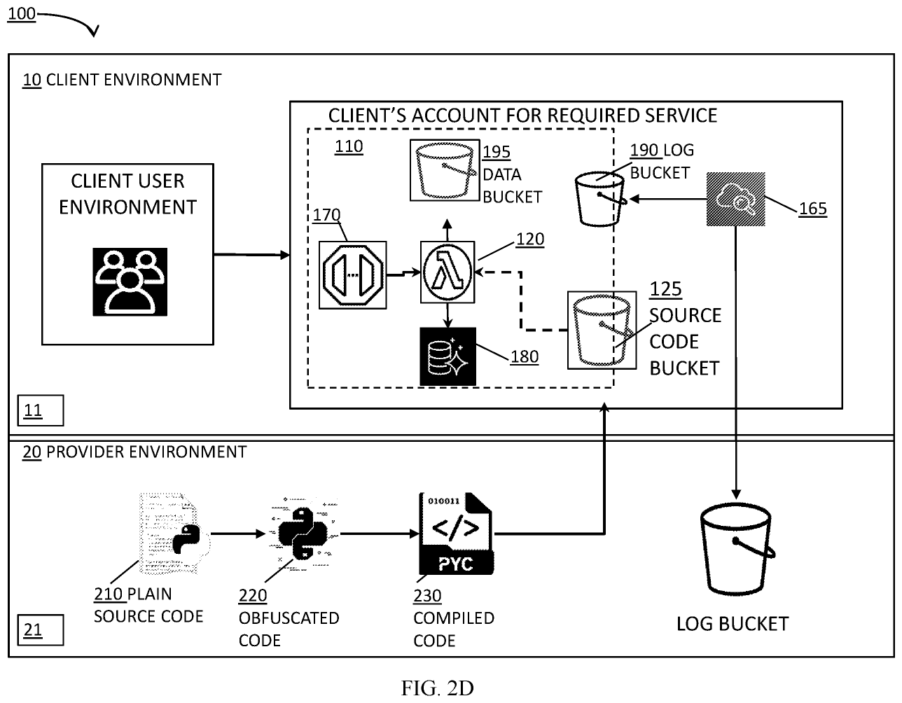

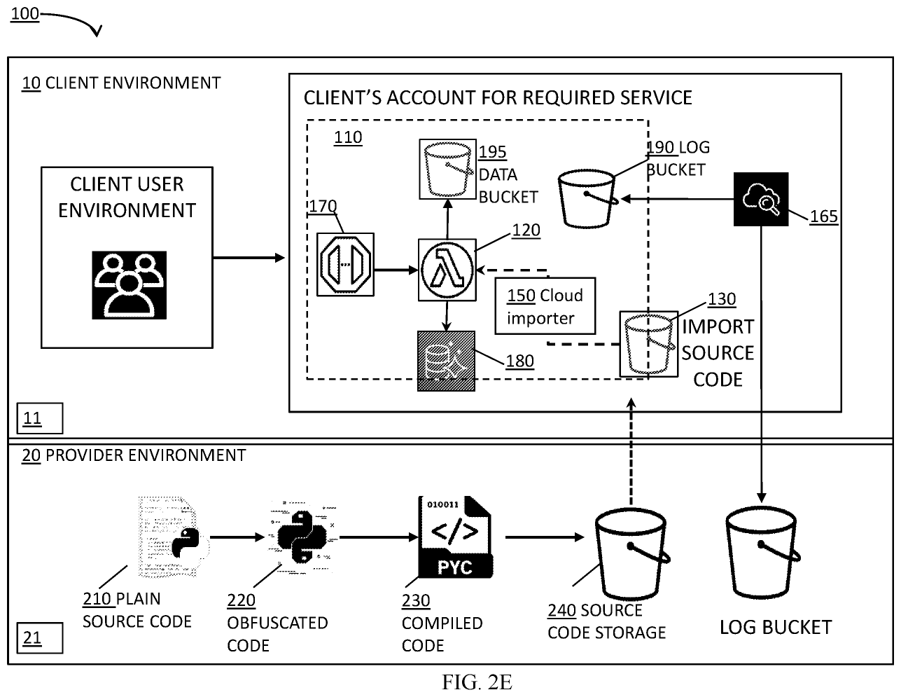

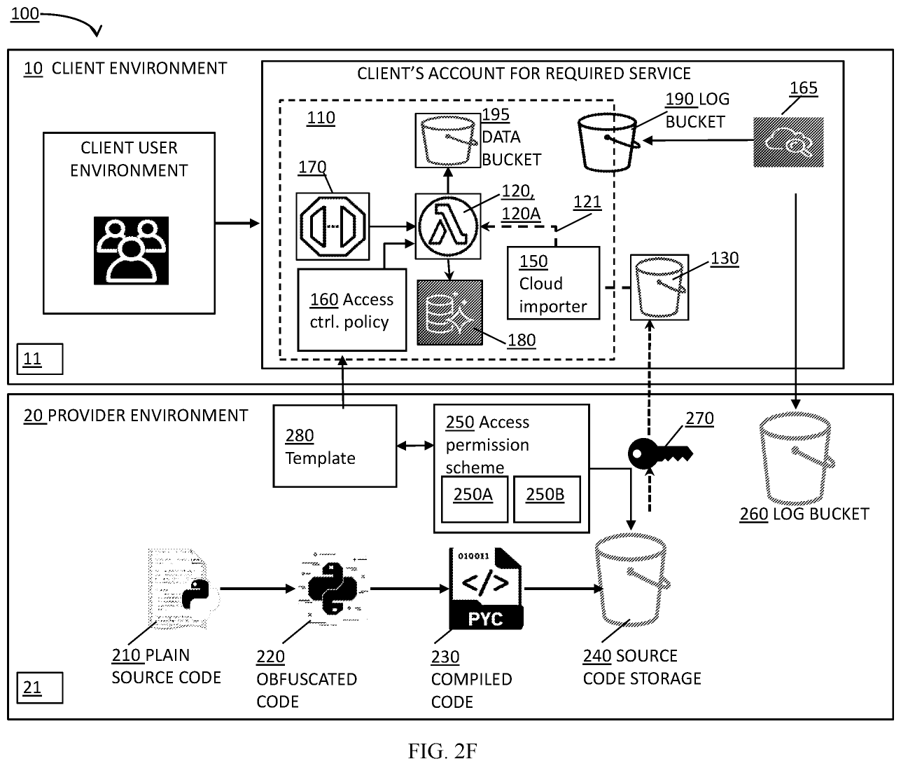

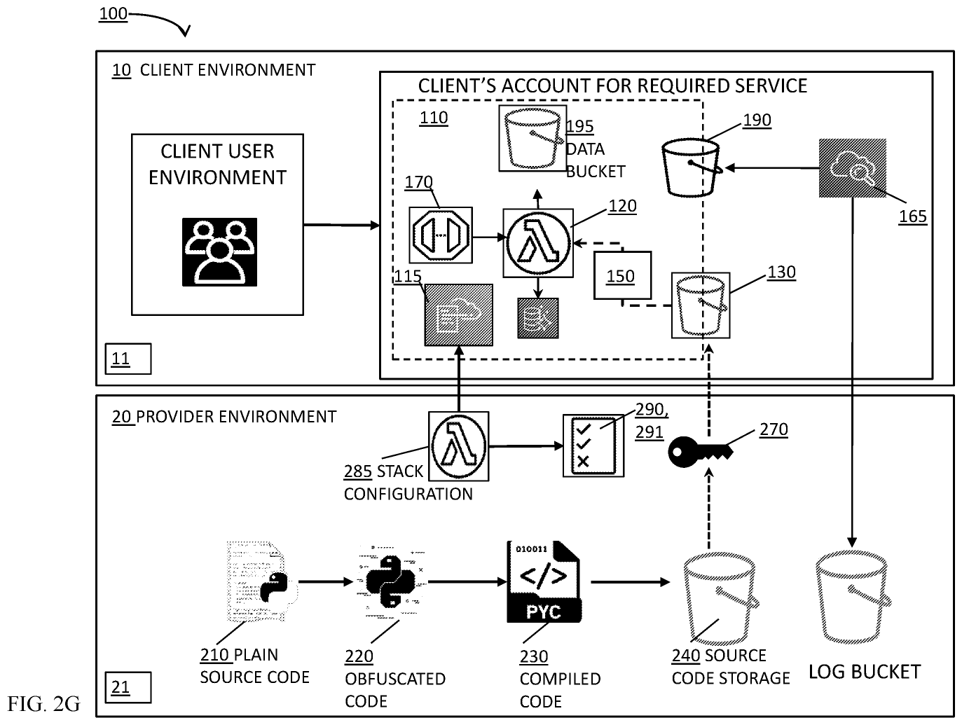

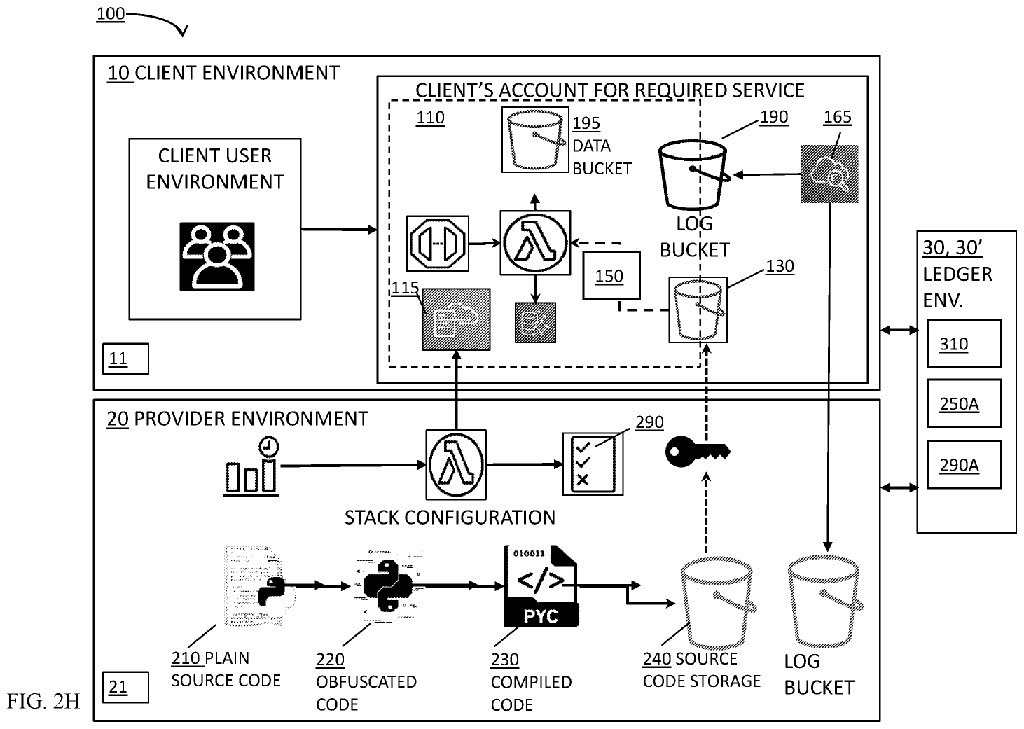

In another example, a cloud computing environment such as AWS may include a one or more cloud storage services such as the AWS S3 bucket. Such elements are depicted in FIG. 2F as bucket elements 240, 260, 190 and/or 195.

In another example, a cloud computing environment such as AWS may include a database (DB) instance 180, such as an Aurora DB, which is a relational database that may be used for data storage.

In this case, the main processing runs inside the AWS Lambda functions and anyone with root access in the account can easily access and download the source code using the provided AWS console ‘inline editor’ function. Access is enabled even when the source code was not written directly in the inline editor, or was uploaded from an S3 bucket.

Accordingly, in some embodiments, the present invention may facilitate protection of source code of provider, such as an Independent Software Vendor (ISV). As elaborated herein, embodiments of the invention may facilitate this code protection by utilizing synergy among a series of security tools. Thus, embodiments of the invention may protect against source code counterfeit and/or theft even when the source code is deployed locally and/or on premises (e.g., on client cloud computing account 10) and may be inaccessible from a provider's (e.g., ISV) cloud computer environment 20.

As known in the art, cloud computing platforms such as AWS provide rigorous enforcement of access policies and deployment. For example, the AWS Identity and Access Management (IAM) facilitates access management to AWS services and resources in a manner that is considered by persons skilled in the art as very difficult to bypass. Additionally, the AWS CloudFormation Stack facilitates deployment and characterization of cloud environment components that is also considered by persons skilled in the art as very difficult to overrun. Embodiments of the invention may utilize these properties of the cloud computing platform (e.g., AWS) to deploy an account on the client's cloud computing environment 10, that may include a computing unit 120 and a proprietary cloud importer mechanism (also referred to herein as an “import infrastructure extension”) 150. Embodiments of the invention may utilize synergy between the high-end security properties of the computing platforms (e.g., AWS) and capabilities of the proprietary import mechanism 150 as elaborated herein, to protect a vendor's source code, even when it is installed or deployed on the client's computing environment 10.

In some embodiments, the present solution uses features and functions of a provided cloud environment as tools to enhance source code protection against unapproved access. In some embodiments, the present solution provides a protection and security level that is substantially equivalent to that provided by the underlying cloud environment itself, thus making it impracticable for an attacker to gain access to the protected source code.

Reference is now made to FIGS. 2A and 2B which are screenshots depicting examples of account dashboards of a cloud computing platform (e.g., AWS). As shown on FIGS. 2A and 2B, according to some embodiments, a system for protection of source code on a client account may apply restriction of access.

For example, as shown on FIGS. 2A and 2Bb, a cloud computing account dashboard may manage user access to the source code. In some embodiments, a source code vendor may restrict access to all resources containing sensitive code. When the source code vendor has initial access to the client account for installation of the source code, the vendor may use this initial access to set up the account in a way that limits or prevents access to the resources containing sensitive code such as computing units (e.g., Lambda), web services such as Amazon's Elastic Compute Cloud (EC2), storage buckets and the like. Once the account is handed over to the client enterprise, client access will be granted only for support and monitoring purposes.

Reference is now made to FIG. 2C which is a schematic block diagram, depicting an example of deployment of components of system 100 for securing computer source code on a cloud computing platform 101, according to some embodiments. As shown on FIG. 2C, modules of system 100 may be deployed on one or more cloud computing environments, denoted herein as one or more client computing environments 10 and one or more provider or ISV computing environments 20.

The one or more client computing environments 10 and one or more provider or ISV cloud computing environments 20 may be associated with, or included in a cloud computing platform 101 (e.g., 101A, 101B), such as Amazon AWS, Google GCP, Microsoft Azure, and the like. It may be appreciated that the various cloud computing environments (e.g., 10, 20) may be associated, or included in the same cloud computing platform (e.g., 101), or associated with different cloud computing platforms (e.g., 101A, 101B).

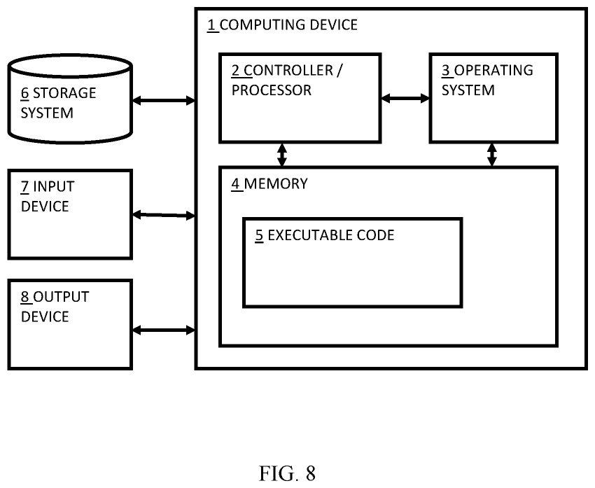

It may be appreciated by a person skilled in the art that the one or more client computing environments 10 and one or more provider or ISV cloud computing environments 20 may be, or may include a representation of one or more respective, underlying, physical computing devices, as elaborated here (e.g., in relation to FIG. 8). For example, a processor (e.g., elements 11, 21) of a cloud computing environment (e.g., 10, 20 respectively) may be, or may represent a physical processing unit as elaborated herein (e.g., processor 2 of FIG. 8). In another example, a memory (e.g., a random access memory (RAM) 120A) of a cloud computing environment (e.g., 10) may be, or may represent a physical, transient memory device as elaborated herein (e.g., memory 4 of FIG. 8). In yet another example, a storage element (e.g., source code bucket 125) of a cloud computing environment (e.g., 10) may be, or may represent a physical storage element as elaborated herein (e.g., storage 6 of FIG. 8).

As elaborated herein, modules of system 100 may secure a vendor's source code, originating from a provider's computing environments 20, even when the code is installed or deployed in a client account 110 of a client computing environment 10.

According to some embodiments, system 100 may include an instantiation of a monitoring service 165, such as the AWS CloudWatch service on the client cloud computing environment 10. Monitoring service 165 may be configured to collect or monitoring operational data in the form of logs, metrics, and events, and providing the provider computer environment 20 with a unified view of AWS resources, applications, and services that run on the client cloud computing environment 10

Monitoring service 165 may produce account alerts, that may be triggered on any attempt to (A) access, add or change privileges for accessing the protected resource; (B) modify existing alerts set up upon account initialization; and/or (C) access one of the computing units' 120 (e.g., Lambdas) running the source code from source code bucket 125. The triggered alerts may be provided using any suitable means, e.g., AWS Simple Notification Service (SNS), in which case a “keep alive” message may be added, to ensure that the SNS is active and was not removed from the account.

Reference is now made to FIG. 2D which is a schematic block diagram depicting another example of deployment of components of system 100 for securing computer source code on a cloud computing platform, according to some embodiments.

As shown in FIG. 2D, system 100 may deploy on client computing environment 10 computer code modules that are not formatted as plain text 210 source code modules.

For example, system 100 may compile plain text 210 source code modules to produce a compiled version 230 of the source code modules. For example, in Python, instead of using the *.py files, compiled *.pyc may be used. In this way, the source code may not be visible in the inline editor of a computing unit 120 such as Lambda. To be able to read the code, an unapproved attacker will need to restore the original file. Simple compiled code could still be relatively easy to reverse engineered to the original source. Therefore, stronger tools should be used for the compiling, such as Cython, which converts the code to C, which enables using a binary compiled code.

In another example, system 100 may perform code obfuscation, to produce an obfuscated version 220 of the modules of source code, and then compile the obfuscated code 220 to produce an obfuscated, compiled version 230 of the source code modules. As known in the art, code obfuscation may change the source code in a way that makes it difficult to read it and understand. There are a variety of obfuscation tools, with support for most of the existing program languages.

Reference is now made to FIG. 2E which is a schematic block diagram depicting another example of deployment of components of system 100 for securing computer source code on a cloud computing platform, according to some embodiments.

As shown in FIG. 2E, system 100 may include an instantiation of a cloud importer module 150 on one or more client accounts 110 in one or more client computing environments 10.

It may be appreciated that cloud importing capabilities may present a plurality of benefits in performance, cost reduction, and source code security. As shown in FIG. 2E, using cloud import facilitates running the service from an enterprise or provider account 20, without having to locate the actual source code, or any version thereof, in the client account's 110 persistent storage.

According to some embodiments, importer 150 may be prohibited from downloading or importing modules of source code to persistent memory (e.g., S3) associated with computing unit 120. This prohibition may be rigorously enforced by the cloud computing platform of account 10. Instead, cloud importer 150 may be configured to download or import compiled and/or obfuscated modules of source code 230 from a source code storage service 240 of the provider's account directly into a transient memory 120A (e.g., RAM) of a computing unit 120 (e.g., Lambda) of the running service. Additionally, or alternatively, cloud importer 150 may be configured to download or import compiled and/or obfuscated modules of source code 230 from source code storage service 240 of the provider's account to a local cache 130, associated with the client's account 110 and/or with a specific computing unit 120.

It may be appreciated that the compiled modules of source code 230 may only reside in the transient memory of computing unit 120 for the duration of code execution. In other words, computing unit 120 may only be able to access the imported, compiled modules of source code 230 during execution or run-time from the transient memory 120A (e.g., RAM) or cache 130 of computing unit 120, and may not be copied or moved elsewhere. Thus, embodiments of the invention may include an improvement over currently available systems and methods for source-code protection, by leveraging the inherent high-end security and authorization capabilities of cloud-computing platforms such as AWS, and enforcing access to source code solely for the purpose of code execution.

Reference is now made to FIG. 2F which is a schematic block diagram depicting another example of deployment of components of system 100 for securing computer source code on a cloud computing platform, according to some embodiments.

According to some embodiments, system 100 may store one or more compiled modules of computer source code 230 on a cloud storage service such as source code storage 240 of provider cloud environment 20, associated with a specific the cloud computing platform (e.g., AWS);

According to some embodiments, source code storage 240 may include two separate parts. A first part may include the original service source code, or compiled and\or obfuscated versions 230 of modules of computer source code. This original code 230 may not be deployed locally on the client cloud account 10, but remotely on a storage service (e.g., AWS S3 bucket) over a cloud computing account 20 controlled by the source code vendor or provider. As elaborated herein, original code 230 may be stored on source code storage 240 in an obfuscated and/or compiled format. Additionally, or alternatively, original code 230 may be encrypted with an encryption key 270 such as an AWS Key Management Service (AWS KMS) key.

A second part of code, stored on source code storage 240, may include source code of cloud importer 150. The second part may be deployed on the client account 20 as part of account 110 protected resources. Upon deployment, cloud importer 150 may be configured to import original source code 230 from the remote source code repository 240 of cloud environment 20, during run-time: When there is an invocation of a specific function or computer code module, cloud importer 150 may import the relevant compiled modules of computer code, and may invoke the imported, relevant modules on computing unit 120 (e.g., Lambda). In this way, modules of compiled code 230 may only be present in the client account 10 during execution, allowing the code provider to maintain full access and control of the source code on cloud environment 20. For example, a provider of source code 230 may change computer code 230, and control access (e.g., deny access) to computer code 230 according to their discretion.

According to some embodiments, system 100 may facilitate a Just in Time (JIT) decryption scheme of imported code. For example, as shown in FIG. 2F, the compiled, obfuscated service source code 230 may be hosted in an encrypted format on source code storage 240 (e.g., S3 bucket) on the software vendor's account on cloud computing environment 20, using, e.g., a unique encryption key 270 (e.g., an AWS KMS key) for the encryption. A processor 21 of cloud computing environment 20 may provide, to the cloud computing unit 120 (e.g., via importer 150) a JIT decryption key, to allow the cloud computing unit 120 to execute the one or more compiled modules of source code 230. In other words, System 100 may only provide privileges to use encryption key 270 to a specific resource, such as a specific computing unit 120 who needs to run the code from the client's account 110, by creating a cross account role, as known in the art.

For example, system 100 may add or associate an access permission scheme 250 to source code storage bucket 240 and/or to one or more compiled modules of source code 230 stored on source code storage bucket 240. Access permission scheme 250 may represent access permissions of one or more resources (e.g., computation units 120) to the compiled modules 230. In other words, access permission scheme 250 may represent permissions, to allow access only to resources (e.g., specific computing unit 120) with the KMS key permissions.

According to some embodiments, a processor 21 of cloud computing environment 20 may receive from a cloud computing unit 120 of a client cloud environment 10 (e.g., via importer 150) a cryptographically verified, run-time request 121 to access the one or more modules of compiled computer source code 230.

The term “run-time request” may be used herein to indicate a request to access or import a module of compiled source code 230 that is done substantially at the same time of an execution, by computing unit 120, of a function or process that is represented by the respective module of compiled computer source code 230.

According to some embodiments, the processor 21 of cloud computing environment 20 may allow cloud computing unit 120 to import (via cloud importer 150) the one or more compiled modules of source code 230 to local, transient memory 120A on cloud environment 10, based on the cryptographic verification of the run-time request 121, and on access permission scheme 250.

This may ensure that the code will only be available, and decrypted in the client account 20 during runtime of the function. Only then, cloud importer 150 will try to read modules of source code 230 from source code storage bucket 240.

In other words, access permission scheme 250, associated with source code storage bucket 240, may ensure that: (a) only code access requests 121 coming from legitimate sources, such as authorized, predetermined computing unit 120 will be served, as verified by the cryptographic verification of the run-time request 121; and (b) modules of source code 230 will only be decrypted during run-time of the service on the authorized computing units 120.

This raises the security level, because the code will be available in the client account 110 in a decrypted format only during runtime of the relevant function, and only on transient memory 120A. When execution of the function ends, the function (which is serverless) will be terminated, and the code will disappear from the enterprise account. In other words, cloud computing unit 120 may be configured or defined to execute the imported one or more compiled modules of computer source code 230 from the local, transient memory 120A, and delete the compiled modules of computer source code 230 therefrom upon termination of execution.

It may be appreciated that although the code may be present on the client account 110 during function execution, computing units 120 (e.g., Lambda functions) do not normally allow user access to run-time code. Therefore, in order to view or access the run-time code, a hacker would need to apply changes to the structure of the computing unit 120 (e.g., Lambda) code. In other words—the hacker would need to overcome the cloud computing platform's (e.g., AWS) security, which would be very difficult to do. Moreover, as may be appreciated by a person skilled in the art, the ephemeral, transient memory 120A of compute unit 120 may be internal, in a sense that it may not be accessed by other resources (e.g., other computing units 120) of client account 110 or client computing environment 10. Therefore, the imported modules of source code 230 may not be accessible to other resource and computing units 120 of client computing environment 10.

According to some embodiments, access permission scheme 250 may include an access control policy definition 250A, such as a rule-based access control (RBAC) policy definition or an attribute-based access control (ABAC) policy definition, as known in the art.

For example, the cloud computing platform may be an Amazon Web Services (AWS) platform. In such embodiments, cloud computing unit 120 may be an AWS Lambda service, local memory 120A may be a RAM memory of the AWS Lambda service 120, the access permission scheme 250 may be implemented using an AWS CloudFormation stack, and the access control policy definition may be a definition of an AWS Identity and Access Management (IAM) policy.

Access control policy 250A definition may be associated to one or more specific cloud computing units 120, so as to apply specific roles and permissions to the associated cloud computing units 120.

During deployment of computing unit 120 (e.g., lambda function) on client account 110 by a cloud platform resource manager (e.g., AWS “CloudFormation”, Google “Cloud Deployment Manager”, Microsoft “Azure resource manager”, and the like), access control policy definition 250A may be instantiated as an access control policy 160, as part of a stack of resources (e.g., AWS CloudFormation stack) of client account 110. Access control policy 160 may be associated to the relevant computing unit 120 (e.g., Lambda) to apply specific roles and permissions to the associated cloud computing units 120.

For example, access control policy 160 may determine read-only access permission of the one or more cloud computing units to the modules of computer source code 230. In another example, access control policy 160 may disallow the one or more cloud computing unit 120 to store imported modules of computer source code 230 to local cloud storage on client computing environment 110. In yet another example, access control policy 250A may disallow the one or more cloud computing units 120 from transmitting or sending the imported modules of computer source code 230 to other resources of client environment 10 or to other computing devices.

According to some embodiments, access permission scheme 250 may further include an authorization, or “chain of trust” data structure 250B, representing authorization of one or more computing units 120 to import one or more compiled modules of computer source 230 from cloud environment 20.

For example, authorization data structure 250B may be, or may include a data structure (e.g., a table, a linked list, and the like) that may associate between: (a) at least one module of computer source code 230; and (b) an identification (e.g., a cryptographically verified identification) of one or more entities upon which the authorization may be applied. In other words, authorization data structure 250B may include a list of entities that are allowed, or disallowed to import one or more compiled modules of computer source 230 from cloud environment 20.

In another example, authorization data structure 250B may associate between (a) at least one module of computer source code 230; (b) an authorization level for importing the at least one module of computer source code; and (c) identification of one or more entities upon which the authorization level may be applied. In other words, authorization data structure 250B may include a list of entities that are allowed, or disallowed to import one or more compiled modules of computer source 230 from cloud environment 20, and also include a level of authorization, including for example a definition of a version of computer source 230, a number of concurrent copies of the module 230 that may be imported, a duration of time for which the import permission is granted, and the like.

The identification of one or more entities may include any combination a definition of computing resources that may be granted access to respective modules of computer source code 230. For example, the identification of one or more entities may include a combination of an identification of one or more cloud platforms, an identification of one or more cloud computing accounts, an identification of one or more cloud computing regions, and/or an identification of one of more cloud computing unit, container, or virtual machine instances.

Reference is now made to FIG. 2G which is a schematic block diagram depicting another example of deployment of components of system 100 for securing computer source code 230 on a cloud computing platform, according to some embodiments.

As known in the art, a stack of a cloud computing account is a collection of cloud computing resources (e.g., computing units, storage buckets, and the like) that may be managed as a single unit, for implementing a cloud computing service or application. All the resources in a stack may be defined by a stack template 280, and may be instantiated by a resource manager on a cloud computing environment as part of deployment of the cloud computing service or application. If the computing service is no longer required, then the stack may be deleted, causing all related resources to be purged. For example, an AWS cloud computing platform may use a CloudFormation resource manager. AWS may enable a user to produce a CloudFormation template, which represents a CloudFormation stack, defining the required computing resources. During deployment of the cloud computing service or application, the CloudFormation stack may be instantiated on the designated cloud computing account, facilitating the functions of the underlying computing service or application.

According to some embodiments, a processor 21 of the source code vendor environment 20 may continuously (e.g., repeatedly over time) query a resource manager of cloud computing environment 10 regarding configuration of computing resources (e.g., computing unit 120) of cloud computing environment 10. For example, processor 21 of the source code vendor environment 20 may access a stack 115 (e.g., an AWS CloudFormation stack) on the enterprise account 110, and read the deployment parameters and configuration from there, as shown in FIG. 2G. Processor 21 of the source code vendor environment 20 may acquire or produce one or more “snapshots” 290 of the deployment's configuration on the enterprise or client account 10 based on the query. This snapshot may be used later as a reference of client account 110 configuration. This may be used in combination with a policy allowing access only from the specific lambda Amazon Resource Name (ARN).

According to some embodiments, processor 21 of the vendor environment 20 may identify or detect stack drift, or change in the computing resources' (e.g., computing unit 120) configuration, based on the acquired snapshots.

For example, computing environment 20 may set a periodic event to read the current content of stack (e.g., AWS CloudFormation stack) 115 from enterprise account 110. Computing environment 20 may then compare the read stack content to a reference snapshot 290, to identify a drift or change in stack 115, that may indicate an attempt to breach access to source code 230. Such drift or change may include, for example changes of computing resources defined by stack 115 (e.g., addition or deletion of computing resources), changes in a configuration of stack 115 components (e.g., changes in permissions attributed to resources such as computing units 120), and the like.

According to some embodiments, the access privilege of computing environment 20 to stack 115 of computing environment 10 may be defined by template 280, and may be instantiated and enforced by the cloud computing platform 101 during deployment of stack 115.

Following an identification of a suspected breach, or drift in the configuration of the computing resources (e.g., computing unit 120), processor 21 of the vendor environment 20 may apply at least one security measure against computing unit 120, based on the identified drift. For example, vendor environment 20 may deny further requests by cloud importer 150 of client account 110 to access modules of compiled source code 230 on source code storage 240.

Reference is now made to FIG. 2H which is a schematic block diagram depicting another example of deployment of components of system 100 for securing computer source code 230 on a cloud computing platform, according to some embodiments.

As shown in FIG. 2H, processor 21 of the vendor environment 20 may continuously (e.g., repeatedly, over time) monitor the enterprise account 110. Processor 21 may validate a configuration of the computing resources (e.g., computing unit 120). If a breach or deviation from a standard configuration and/or behaviour is detected, (e.g., an attempt to access computing unit 120 configuration via a system console is reflected in cloud logs 190), then processor 21 may and produce an alert 291, based on the determined suspected breach. For example, alert 291 may be, or may include a notification (e.g., an email, a short messaging service (SMS) and the like) that may be sent to an administrator's computing device.

Processor 21 may evaluate the significance of alerts 291 based on timing and recurrence. For example, certain alerts (e.g., access to Lambdas) may be expected during the initial period after source code deployment (e.g., in connection with security validation). However, if recurring alerts 291 continue after an initial phase, they may be an indication of unapproved activity. Once such alerts are encountered, access configuration may be modified to prevent future unapproved access to the source code bucket 240.

Additionally, processor 21 of the vendor environment 20 may continuously (e.g., repeatedly, over time) modify or update the source code 230, e.g., using compilation and/or obfuscation. This may be done using a scheduled event to repeatedly (e.g., nightly, weekly, and/or otherwise periodically) obfuscate and/or compile code 230.

According to some embodiments, system 100 may be associated with a third-party cloud-computing environment 30, corresponding to or belonging to a trusted, third-party person or organization. The term “third-party” may be used in this context to indicate an organization or person that is legally related neither to the provider or vendor of cloud-computing environment 30 nor to the client or customer of client cloud-computing environment 10. The third party organization may be “trusted” in a sense that any dispute or disagreement between the provider of provider environment 30 and the client of client cloud-computing environment 10 may be automatically resolved or arbitrated by cloud-computing environment 30 of the trusted, third-party entity. For example, third-party cloud-computing environment 30 may include a ledger 310, that may be configured to automatically resolve or arbitrate such disputes between the client and provider, as elaborated herein.

According to some embodiments, a processor 21 of provider environment 20 may associate a resource manager (e.g., AWS CloudFormation stack) 115 of cloud environment 10 to third-party ledger account 30′ on third-party cloud environment 30. For example, processor 21 of provider environment 20 may provide ledger account with access privileges to read a content of stack 115 of cloud environment 10. Additionally, processor 21 of provider environment 20 may provide a copy of access permission scheme 250 (denoted 250A in FIG. 2H) to the third-party ledger account 30′.

According to some embodiments, processor 21 of provider environment 20 may continuously (e.g., repeatedly over time) query the stack 115 resource manager of the cloud environment 10 regarding configuration of computing resources (e.g., computing unit 120). processor 21 of provider environment 20 produce one or more snapshots 290 of the stack configuration (e.g., computing unit 120 configuration) and identify a suspected drift in the configuration based on said queries, as elaborated herein (e.g., in relation to FIG. 2G).

Following identification of such drift, processor 21 of provider environment 20 may send a request message to third-party ledger 310. This message may include a request to confirm occurrence of the suspected drift in the configuration of the stack (e.g., the computing unit 120), based on at least one snapshot (denoted 290A) and the access permission scheme 250A.

According to some embodiments, third-party ledger 310 may verify a correctness of the suspected drift in the configuration of the stack (e.g., the computing unit 120), and may respond with an appropriate answer, or notification to provider environment 20 and/or client environment 10. Processor 21 of provider environment 20 may subsequently apply at least one security measure against the computing unit 120, based on a response from the third-party ledger. For example, if the ledger 310 response includes confirmation of the suspected drift, then processor 21 of provider environment 20 may deny further requests by cloud importer 150 of client account 110 to access modules of compiled source code 230 on source code storage 240.

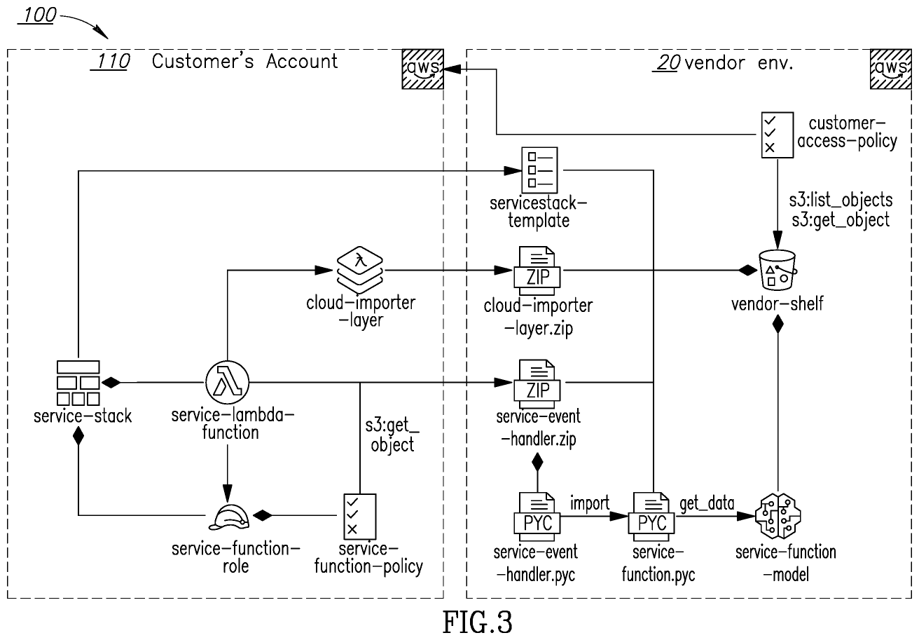

FIGS. 3-7 illustrate details of an implementation process for a protection scheme for securing source code hosted on a private cloud environment and/or using their private accounts, according to some embodiments of the present disclosure.

In some embodiments, as illustrated in FIG. 3, a software vendor may perform an initial setup of a private enterprise cloud account on a public cloud platform, e.g., AWS. In some embodiments, the account setup may utilize the standard AWS IAM access control mechanism as follows:

Host all Vendor source code in an S3 Bucket (‘vendor-shelf’) at an account controlled by the vendor.

Establish an IAM policy with respect to the enterprise account granting the enterprise a read-only access to the relevant source code or any other assets only as may be required for initial service-stack launch.

In the enterprise account, one or more instances (e.g., test, stage, production) of one or more services could be instantiated in the form of AWS CloudFormation Stack (service-stack).

The service-stack may be formed using a corresponding AWS CloudFormation Stack Template (service-stack-template) retrieved from the vendor-shelf Bucket.

The service-stack will normally have one or more AWS Lambda Functions (service-function) associated with a corresponding IAM Role (service-function-role), which specifies an IAM Policy (service-function-policy) granting a read-only access to the service-function Event Handler Zip file (service-event-handler.zip).

The service-function uses an AWS Lambda Function Layer (cloud-importer-layer), which provides implementation of Python Cloud Importer 150.

Create a cloud-importer-layer within a separate AWS CloudFormation Stack (as further detailed below).

The service-function-handler.zip contains a compiled version of AWS Lambda Event Handler (service-function-handler.pyc) which in turn utilizes a cloud importer mechanism mentioned above, to invoke real function processing algorithm (service-function.pyc).

In some cases, the service-function.pyc will need to download from S3 a pre-trained Machine Learning Model (service-function-model) also supported by the Cloud Importer mechanism.

This setup stage provides source code protection measures. Specifically, the enterprise account will only gain limited access to a compiled Python code only, and will not have any direct access to the any real functionality, e.g., any algorithm or machine learning model, because the actual source code is generally retrieved directly to the Lambda Function RAM 120A.

However, this initial setup may still be vulnerable to an attack. For example, an attacker could download the service-function-handler.zip by leveraging general enterprise account read-only access privileges. After downloading, the attacker could modify it such that the service-function and service-function-model, after being imported into the Lambda Function RAM, will be uploaded to another S3 Bucket on the enterprise account. Then, the attacker may attempt to reverse-engineer the downloaded file, to obtain the original source code. In such case, the vendor would have no knowledge regarding the occurrence of the attack.

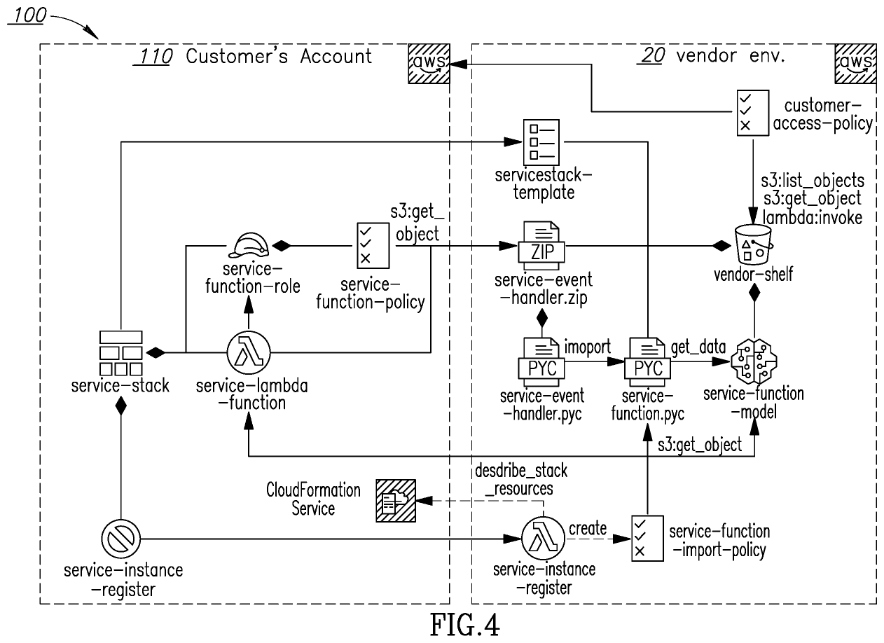

Accordingly, additional protection layers may be applied, as further illustrated in FIG. 4. Initially, the service-stack launched in the enterprise account is not granted access to service-function.pyc, neither to service-function-model. Thus, if the service-event-handler.pyc is invoked, it will fail with Access Denied exception. This is because each service Lambda function is granted with minimal initial privileges upon setup, wherein the initial privileges are automatically derived from high level service specification. For example, if a service function does not write to persistent cloud storage, it will not get permission to do so.

In addition to traditional AWS CloudFormation resources, the service-stack allocates a service registration Custom Resource (service-instance-register). This service-instance-register invokes remotely a service-instance-register Lambda Function on the vendor's account (see below for how this is achieved from the Access Control perspective).

The service-stack identifier is sent as a parameter. The service-instance-register Lambda Function sends a request to AWS CloudFormation service on the Enterprise account to obtain all details of the service-stack. Upon successful validation that the service-stack resources structure conforms to the original service-stack-template, the service-instance-register creates a new service-function-import-policy which grants a read-only access to service-function.pyc and, optionally, service-function-model specifically to that service-function Lambda.

Thus, to gain access, a potential attacker will need to breach AWS CloudFormation service, in order to trick the service-instance-register to grant access to service-function.pyc or service-function-model. Should any concern about the service-stack integrity be raised, the access permission is not granted, and all subsequent invocations of the service-function Lambda will fail with an Access Denied exception.

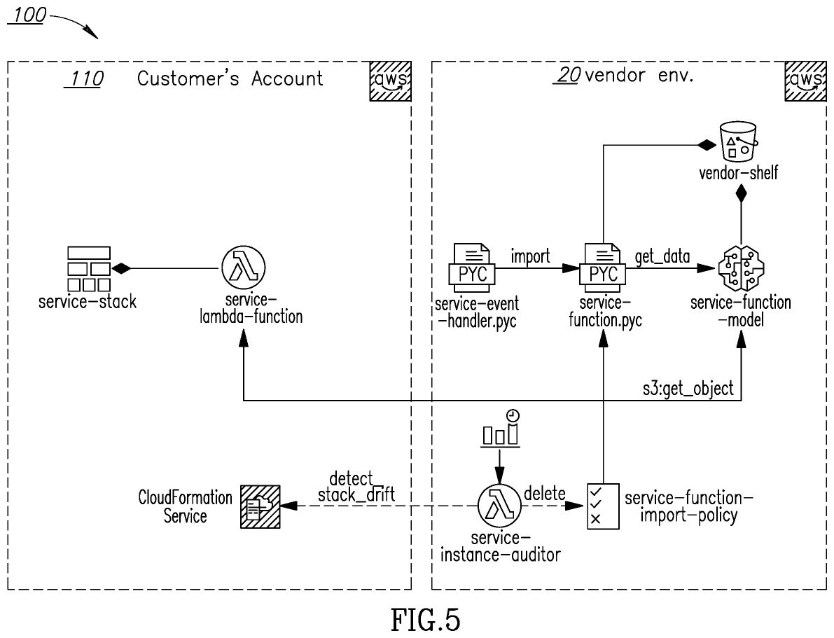

In some embodiments, a monitoring stage setup for a CloudFormation stack drift may be performed, as illustrated in FIG. 5.

In the case that an attacker may gain access to modify the service-stack layer, it is important to periodically check the service-stack integrity, and cancel unapproved access permissions.

First, if an attacker tries to modify the service-stack via the AWS CloudFormation update-stack mechanism, the same validation process will take place, and if unauthorized discrepancy is detected, the access permission will be revoked. However, this process does not address the potential issue of an attacker trying to modify the service-function Lambda directly, either via AWS Console, SDK, or CLI. To mitigate this risk, the following periodic integrity check may be performed. A periodic check of AWS CloudFormation stack drift may be performed by a service-instance-auditor. This check is usually triggered by a periodic event set with a frequency which reflects a risk-based assessment. If any unapproved drift from the original configuration specified by service-stack-template is detected, the access permission grant is cancelled. Thus, in order to bypass that protection layer, the attacker will need to hack underlying infrastructure, e.g., AWS CloudFormation and/or IAM.

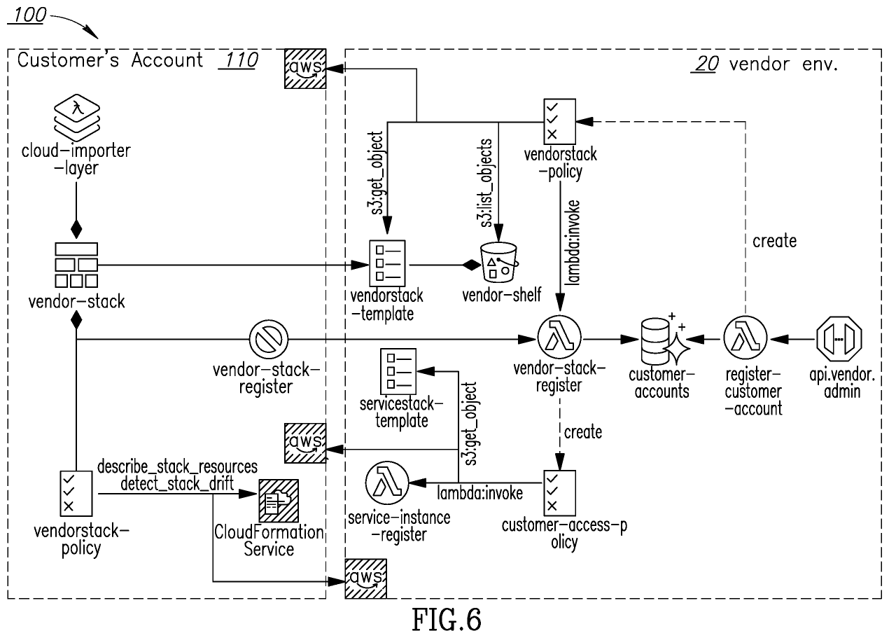

In some embodiments, the vendor's account may be registered, to get a permission to call AWS CloudFormation service on the enterprise account, and to allow the enterprise account to get a permission to invoke service-instance-register, as further illustrated in FIG. 6.

When a new enterprise account is registered via the vendor's Admin API:

The register-customer-account Lambda Function stores the enterprise account details, e.g., in a customer-accounts database.

A new vendorstack-policy IAM Policy is created, granting read-only access for the registered account to vendorstack-template invocation permissions for the vendorstack-register Lambda Function.

Upon, confirmation from the vendor's account (e.g., manual confirmation), the enterprise account administrator launches a special vendor-stack using the vendorstack-template, in which it has read-only access.

The vendor-stack contains a cloud importer Lambda Layer to be used by service-function Lambda as detailed above, a vendorstack-policy IAM Policy granting required AWS CloudFormation API access to the Enterprise account, and, a Custom AWS CloudFormation Resource that invokes the vendorstack-register Lambda Function, in which it was granted an invocation permissions.

The vendorstack-register Lambda Function performs necessary validations, updates the customer-accounts database and, if everything checks, creates a service-stack-policy IAM Policy that grants the enterprise account read-only access permission to one or more service-stack-template and invocation permission for the service-instance-register Lambda Function.

Thus, the vendor is provided with robust access control for all critical vendor resources, without introducing excessive operational costs, e.g., as a result of using encryption. Preliminary analysis indicates that using encryption would require a similar level of access control to encryption, without introducing any extra protection layer, because if an attacker manages to breach AWS to get access to the vendor account resources, the attacker would also be able to gain an access to the encryption key.

In some embodiments, the present protection scheme may also support a shared file system for Lambda Function.

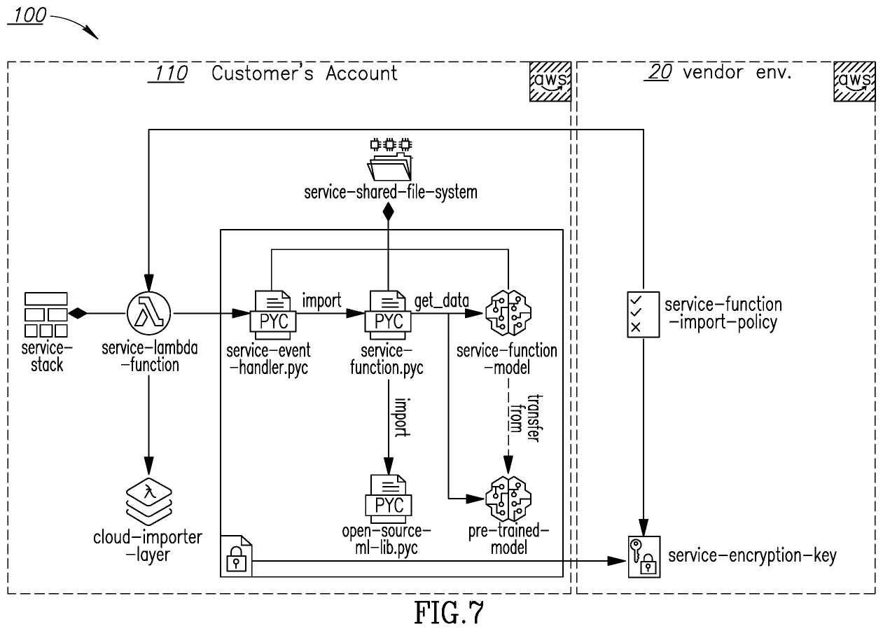

FIG. 7 illustrates an integration of the present protection scheme with a shared file system. As can be seen, this integration retains the cloud importer layer, with the assumption that some or all of the service-function files may be, e.g., for efficiency or client privacy protection reasons, located at the service-shared-file-system. Generally speaking, the service-shared-file-system may be treated as an additional cache tier. However, all sensitive information (source code and data) are stored on the service-shared-storage in encrypted form, and are decrypted by the cloud importer layer directly into RAM. The encryption is performed separately for each enterprise account service installation (e.g., account and/or region, such that two separate services deployed on two separate accounts/regions will lead to four separate encryptions). The service-encryption-key is stored on the vendor's account KMS, and its access is regulated the same way as it was done for cloud import from S3.

The present invention may be a system, a method, and/or a computer program product. The computer program product may include a computer readable storage medium (or media) having computer readable program instructions thereon for causing a processor (e.g., 11, 21) to carry out aspects of the present invention.

Reference is now made to FIG. 8 which is a block diagram depicting a computing device, which may be included within an embodiment of a system for securing computer source code on a cloud computing platform, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may securing computer source code on a cloud computing platform as described herein. Although, for the sake of clarity, a single item of executable code 5 is shown in FIG. 8, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to cloud computing environments may be stored in storage system 6 and may be loaded from storage system 6 into memory 4 where it may be processed by processor or controller 2. In some embodiments, some of the components shown in FIG. 8 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

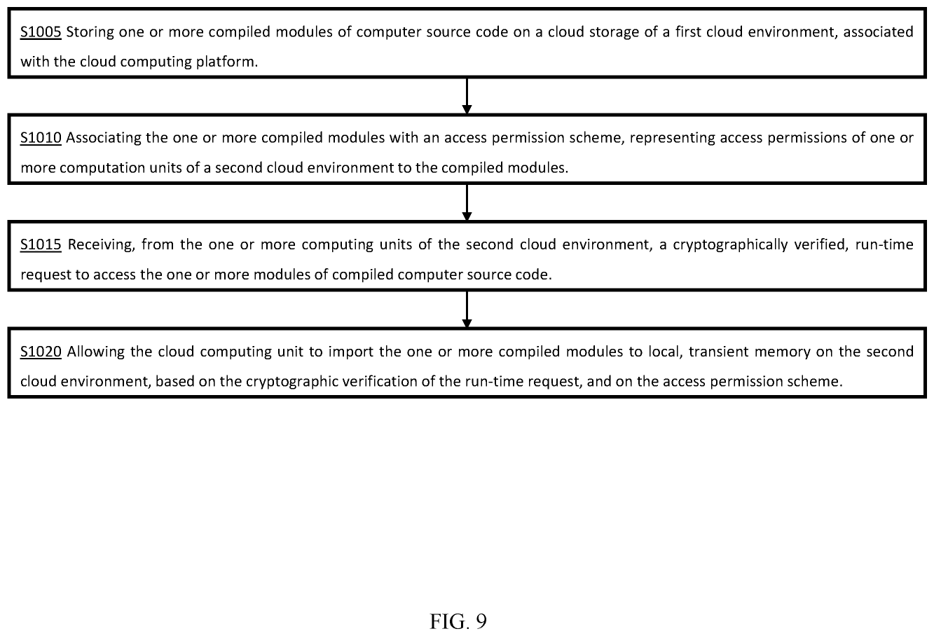

Reference is now made to FIG. 9 which is a flow diagram depicting a method of securing computer source code on a cloud computing platform (e.g., elements 101, 101A, 101B of FIG. 2C) by at least one processor (e.g., element 21 of FIGS. 2C-2H) of the cloud computing platform 101, according to some embodiments.

As shown in step S1005, processor 21 may store one or more compiled modules of computer source code (e.g., element 230 of FIG. 2D) on a cloud storage element or module (e.g., storage 240 of FIG. 2E) of a first cloud environment (e.g., provider cloud environment 20 of FIG. 2D), associated with the cloud computing platform 101.

As shown in step S1010, processor 21 may associate the one or more compiled modules 230 with an access permission scheme (e.g., access permission scheme 250 of FIG. 2F), representing access permissions of one or more computation units (e.g., computation unit 120 of FIG. 2D) of a second cloud environment (e.g., client cloud environment 10 of FIG. 2D) to the compiled modules 230.

As shown in step S1015, processor 21 may receive from a cloud computing unit 120 of the second cloud environment 10 a cryptographically verified, run-time request (e.g., element 121 of FIG. 2F) to access the one or more modules of compiled computer source code 230.

As shown in step S1020, processor 21 may allow, or disallow the cloud computing unit to import the one or more compiled modules to local, transient memory (e.g., element 120A of FIG. 2F) on the second cloud environment 10, based on the cryptographic verification of the run-time request 121, and on the access permission scheme 250.

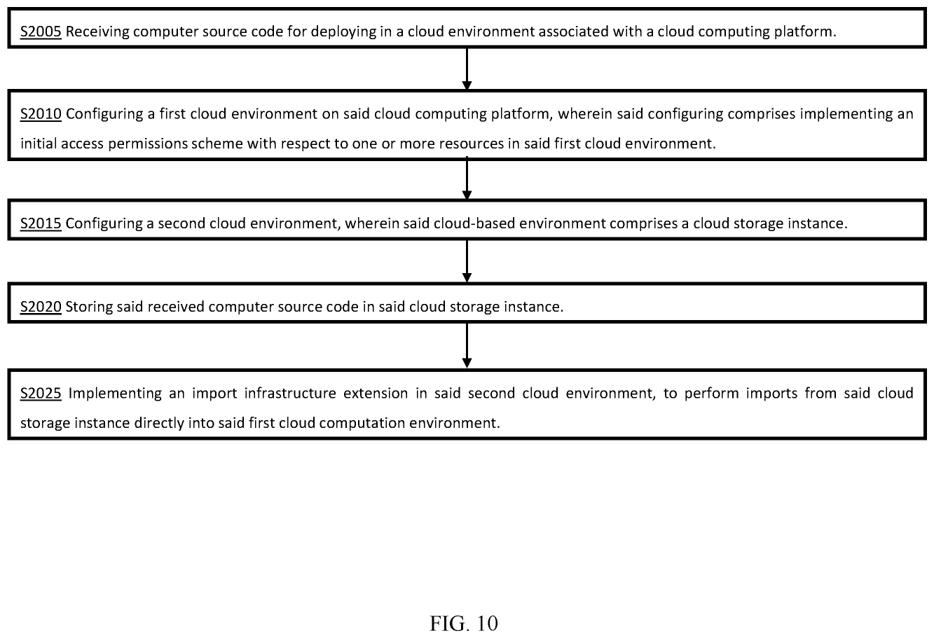

Reference is now made to FIG. 10 which is a flow diagram depicting a method of securing computer source code on a cloud computing platform (e.g., elements 101, 101A, 101B of FIG. 2C) by at least one processor (e.g., element 21 of FIGS. 2C-2H) of the cloud computing platform 101, according to some embodiments.

As shown in step S2005, processor 21 may receive computer source code (e.g., element 230 of FIG. 2F) for deploying in a cloud environment (e.g., client cloud environment 10 of FIG. 2F) associated with a cloud computing platform (e.g., elements 101, 101A of FIG. 2C) such as Amazon AWS.

As shown in step S2010, processor 21 may configure a first cloud environment 10 on said cloud computing platform 101, wherein said configuring comprises implementing an initial access permissions scheme (e.g., access permission scheme 250 of FIG. 2F) with respect to one or more resources (e.g., computing unit 120 of FIG. 2F) in said first cloud environment 10.

As shown in step S2015, processor 21 may configure a second cloud environment (e.g., environment 20 of FIG. 2F). Cloud-based environment 20 may include a cloud storage instance or a cloud storage service 240. According to some embodiments, second cloud environment 20 may be implemented on cloud computing platform 101 (e.g., 101A, such as Amazon AWS). Alternatively, second cloud environment 20 may be implemented on a different cloud computing platform 101 (e.g., element 101B of FIG. 2C, such as Microsoft Azure).

As shown in steps S2020 and S2025, processor 21 may store the received computer source code (e.g., 230) in said cloud storage instance 240. Processor 21 may implement an import infrastructure extension (e.g., cloud importer 150 of FIG. 2F) in the first cloud environment 10, to perform import of from cloud storage instance 240 directly into said first cloud computation environment 10, based on access permission scheme 250.

For example, processor 21 may allow, or disallow the cloud computing unit 120 to import, via cloud importer 150, one or more modules of the one or more received computer source code 230 to local, transient memory (e.g., element 120A of FIG. 2F) on the cloud environment 10, based on the access permission scheme 250.

As elaborated herein, embodiments of the invention may include a practical application for managing and securing computer source code on a cloud computing environment.

Embodiments of the invention may include several improvements over currently available cloud-based computer technology, as elaborated herein.

For example, embodiments of the invention may leverage the inherent high-end security and authorization capabilities of cloud-computing platforms such as AWS, and enforce source-code protection by limiting access of cloud-based client accounts to source code solely for the purpose of code execution.

In another example, embodiments of the invention may facilitate continuous monitoring, by a first cloud-based computing environment (e.g., an ISV account) of computing resource configuration in a second cloud-based computing environment (e.g., a client account), and application of one or more security measures (e.g., denial of code import) upon detection of a breach of a configuration, as elaborated herein.

In yet another example, embodiments of the invention may facilitate automated arbitration and/or resolution of disputes over source code usage by a trusted, third party cloud-based computing environment (e.g., a ledger account), as elaborated herein.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of securing computer source code on a cloud computing platform by at least one processor of the cloud computing platform, the method comprising:
storing one or more compiled modules of computer source code on a cloud storage of a first cloud environment, associated with the cloud computing platform;
associating the one or more compiled modules with an access permission scheme, representing access permissions of one or more computation units of a second cloud environment to the compiled modules;
receiving, from the one or more computing units of the second cloud environment, a cryptographically verified, run-time request to access the one or more modules of compiled computer source code; and
allowing the cloud computing unit to import the one or more compiled modules to local, transient memory on the second cloud environment, based on the cryptographic verification of the run-time request, and on the access permission scheme.

2. The method of claim 1, wherein the cloud computing unit is defined to execute the imported one or more compiled modules of computer source code from the local, transient memory, and delete the compiled modules of computer source code therefrom upon termination of execution.

3. The method according of claim 1, wherein the access permission scheme comprises: (a) an access control policy; and (b) an authorization data structure, representing authorization of one or more computing units to import one or more compiled modules of computer source from the first cloud environment.

4. The method of claim 3, further comprising associating the access control policy to the cloud computing unit, and wherein said policy (a) determines read-only access permission of the cloud computing unit to the modules of computer source code, and (b) disallows the cloud computing unit storage of the imported modules of computer source code to local cloud storage.

5. The method according of claim 4, wherein the cloud computing platform is an Amazon Web Services (AWS) platform, and wherein the cloud computing unit is an AWS Lambda service, and wherein the local memory is a random access memory (RAM) of the AWS Lambda service, and wherein the access control policy is an AWS Identity and Access Management (IAM) policy, and wherein said access permission scheme is implemented using an AWS CloudFormation stack.

6. (canceled)

7. The method of claim 4, further comprising encrypting the one or more compiled modules of computer source code on the cloud storage of a first cloud environment, and wherein allowing the cloud computing unit to import the one or more modules of source code comprises providing, to the cloud computing unit, a just in time (JIT) decryption key, to allow the cloud computing unit to execute said the one or more compiled modules of source code.

8. The method of claim 4, further comprising:
repeatedly querying a resource manager of the second cloud environment regarding configuration of the computing unit;
producing one or more snapshots of the computing unit configuration, based on said queries;
identifying a drift in the configuration of the computing unit, based on said snapshots; and
applying at least one security measure against the computing unit, based on said identified drift.

9. The method of claim 4, further comprising:
associating a resource manager of the second cloud environment with a third-party ledger account, on a third cloud environment;
providing the access permission scheme to the third-party ledger account;
repeatedly querying a resource manager of the second cloud environment regarding configuration of the computing unit;
producing snapshots of the computing unit configuration, based on said queries;
identifying a suspected drift in the configuration of the computing unit, based on said snapshots;
sending a request message to the third-party ledger, said message comprising a request to confirm occurrence of drift in the configuration of the computing unit, based on at least one snapshot and the access permission scheme; and
applying at least one security measure against the computing unit, based on a response from the third-party ledger.

10. The method of claim 3, wherein said authorization data structure comprises an association between: (a) at least one module of computer source code, (b) an authorization level for importing the at least one module of computer source code, and (c) identification of one or more entities upon which the authorization level is applied, and wherein the identification of one or more entities is selected from a list consisting of: an identification of a cloud platform, an identification of a cloud account, an identification of a cloud region, and an identification of one of more computing unit instances.

11. (canceled)

12. (canceled)

13. A system comprising:
at least one hardware processor; and
a non-transitory computer-readable storage medium having stored thereon program instructions, the program instructions executable by the at least one hardware processor to:
receive computer source code for deploying in a cloud environment associated with a cloud computing platform,
configure a first cloud environment on said cloud computing platform, wherein said configuring comprises implementing an initial access permissions scheme with respect to resources in said first cloud environment,
configure a second cloud environment on said cloud computing platform, wherein said cloud-based environment comprises a cloud storage instance,
store said received computer source code in said cloud storage instance, and
implement an import infrastructure extension in said second cloud environment, to perform imports from said cloud storage instance directly into said first cloud computation environment.

14. The system of claim 13, wherein said cloud computing platform is Amazon Web Services (AWS) and said cloud storage instance is Simple Storage Service (S3).

15. The system according to claim 13, wherein said initial access permissions scheme is implemented using an AWS CloudFormation Stack.

16. The system according to claim 15, wherein said program instructions are further executable to lock down said permission scheme, such that no modifications to said Cloud Formation Stack are permitted.

17. The system according to claim 15, wherein access permission to said source code is granted to any Lambda Function ARN upon initial validation of the Cloud Formation Stack instance integrity.

18. The system according to claim 13, wherein said program instructions are further executable to:
(i) generate periodic snapshots of a current access permissions scheme in said first cloud environment; and
(ii) compare each of said periodic snapshots to said initial access permissions scheme, to identify any drift from said initial access permissions scheme.

19. The system according to claim 13, wherein said import infrastructure extension is configured for a dynamic runtime environment, and wherein said importing is performed directly into a cloud computation unit associated with said first cloud environment.

20. The system of claim 19, wherein said cloud computation unit is AWS Lambda.

21. The system of claim 19, wherein said dynamic runtime environment is one of: Python, JavaScript family, JVM family, Julia, .NET family, Linux Shared Objects, and Microsoft DLLs.

22. The system according to claim 13, wherein said initial permissions scheme is configured for providing alerts to said second cloud environment with respect to any attempted violations of said initial permissions scheme.

23. The system according to claim 13, wherein said program instructions are further executable to modify said source code by at least one of: code obfuscation, code compilation, and code encryption.

24.-35. (canceled)
